(19) United States
(12) Patent Application Publication
(10) Pub. No.: US 2025/0259813 A1
(43) Pub. Date: Aug. 14, 2025

(54) SWITCH

(71) Applicant: Siemens Aktiengesellschaft, München (DE)

(72) Inventors: Thomas Driehorn, Teltow (DE); Peter Kopaczewski, Berlin (DE); Marvin Wagner, Berlin (DE)

(21) Appl. No.: 19/049,203

(22) Filed: Feb. 10, 2025

(30) Foreign Application Priority Data
Feb. 9, 2024 (DE) 10 2024 201 200.9

(51) Int. Cl. H01H 71/04; G06F 11/07; H01H 71/00

(52) U.S. Cl. CPC H01H 71/04; G06F 11/0769; G06F 11/0775; H01H 2071/006; H01H 2071/042; H01H 2071/044

(57) ABSTRACT

A switch contains an electronic overcurrent trip unit, a memory associated with the electrical overcurrent trip unit for storing error-related log files, and a display. Accordingly, the switch is configured for conversion of information stored in error-related log files into a graphical code and for output of the code on a display. This simplifies the relaying of error-related information, e.g. by photographing the information by use of a mobile phone and sending it to a service location.

### CROSS-REFERENCE TO RELATED APPLICATION

This application claims the priority, under 35 U.S.C. § 119, of German Patent Application DE 10 2024 201 200.9, filed Feb. 9, 2024; the prior application is herewith incorporated by reference in its entirety.

### FIELD AND BACKGROUND OF THE INVENTION

The invention relates to a switch that permits output of error-related data.

Modern circuit breakers of the ACB (Air Circuit Breaker) and MCCB (Molded Case Circuit Breaker) type are equipped with powerful and diversely parametrizable electronic overcurrent trip units (ETU-Electronic Trip Unit). They are often provided with a display that provides a graphical user interface for setting parameters and displaying measured values, data and parameters. Such a display is described e.g. in non-prosecuted German patent application DE 10 2020 210 973 A1, corresponding to U.S. Pat. No. 11,990,302.

Since overcurrent trip units are complex devices that offer a multitude of setting parameters and also have to interact with other components, such as a breaker identification module (BIM) and an Option Plug add-on module (a module for providing additional functions, typically in the form of a rated current module, or rating plug, extended with regard to the functions), there are also possibilities of misconfiguration and, in the event of a component malfunction, the occurrence of internal errors. These are typically displayed to the user in the form of centralized fault indications via LEDs (warning/fault) and display text messages. However, so as not to irritate the user-they cannot correct many of these errors themselves-detailed error messages in the form of plain text are not displayed, but rather centralized fault indications.

The exact cause of the fault is known in the ETU and is stored in retentive memories in internal logs, or error logs, containing exact error information (cause, address, time stamp). The logs can only be read by a service engineer using special equipment. Since the logs contain a large amount of data, they cannot be displayed in text form in the display of the ETU. As a result, in some instances a customer engineer must go to customers for fault analysis (e.g. reading the logs) or the device must be removed and sent to the customer service department.

In the event of a fault, the customer is often tied to the manufacturer's customer service department. The customer service department must use the customer's information regarding behavior or displays to isolate the possible cause of the fault on the phone or by e-mail and to issue appropriate recommendations for action, or to send out spare parts configured for the customer. The customer can only pass on the content of the centralized fault indication to the customer service department in this case. The detailed data in the logs cannot be read without special equipment and in particular by the user.

### SUMMARY OF THE INVENTION

The object of the invention is to improve the provision of error-related information by a switch.

The object is achieved by a switch according to the independent switch claim or a method according to the independent method claim. Advantageous developments are specified in the dependent claims.

One aspect of the invention relates to a switch, in particular a low-voltage switch, e.g. an ACB or an MCCB, having an electronic overcurrent trip unit, or an ETU. This ETU has an associated internal or external memory for storing error-related log files. The switch moreover contains a display. The inventive switch is designed for conversion of information stored in error-related log files (e.g. the date and time of an error, an identification number of the corresponding log file entry, an error code, etc.) into a graphical code (e.g. one-or multi-dimensional graphical code, e.g. barcode, QR code, data matrix code, etc.) and for output of the code on a display. The display may be the display of the switch. However, it is also conceivable that the switch contains a communication interface and is designed for transmission to a terminal (e.g. mobile phone) having a display for output of the code on this display.

In the event of a fault, the user can thus have the graphical code displayed on the instructions of the customer service department, can photograph the graphical code, e.g. using a cellphone, i.e. without a special additional device, and can transfer it to the customer service department.

According to one embodiment, the switch is configured for conversion of information stored in error-related log files into a graphical code by the electronic overcurrent trip unit or a data processing unit (e.g. CPU or MCU) of a display of the switch.

According to a development of the switch, the information contains an error code (e.g. centralized fault indication), and the switch is configured for extraction of the error code by the electronic overcurrent trip unit and for output on the display of the switch. The switch can then be configured for alternative display of the error code and the graphical code on the display. That is to say that a conventional error display (error code) is combined with the inventive display of a graphical code, the two being associated with one another (i.e. indicating the same fault), but only being able to be displayed alternately, a very ergonomic approach that avoids the misunderstandings possible with simultaneous display. The graphical code will include more information than the conventional error display, but may contain the error code in particular. It is possible to change over to display of the graphical code e.g. by means of a key combination on the display.

According to one embodiment, the display of the graphical code is password protected. This can be a password specific to the switch.

The invention also comprises a method for output of error-related information by means of an inventive switch. The method involves information stored in error-related log files being converted into a graphical code, and the graphical code being output on a display.

According to a development of this method, there is provision for extraction or reading of an error code from an error-related log file entry and for extraction of further information from the error-related log file entry. The error code and the further information are converted to a graphical code (the information extraction of the error code and the further information for the graphical code can be done in a single step). The error code is moreover provided for output on the display. The graphical code is also provided for output on the display, it being possible to change between output of the error code and the graphical code on the display.

Other features which are considered as characteristic for the invention are set forth in the appended claims.

Although the invention is illustrated and described herein as embodied in a switch, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a block diagram of portion of a circuit breaker, different units of the switch being shown schematically;

FIG. 2 is a front view of the circuit breaker having a display;

FIG. 3 is a schematic representation of a conversion of error-related information into a graphical code; and

FIG. 4 is an illustration of an inventive method.

### DETAILED DESCRIPTION OF THE INVENTION

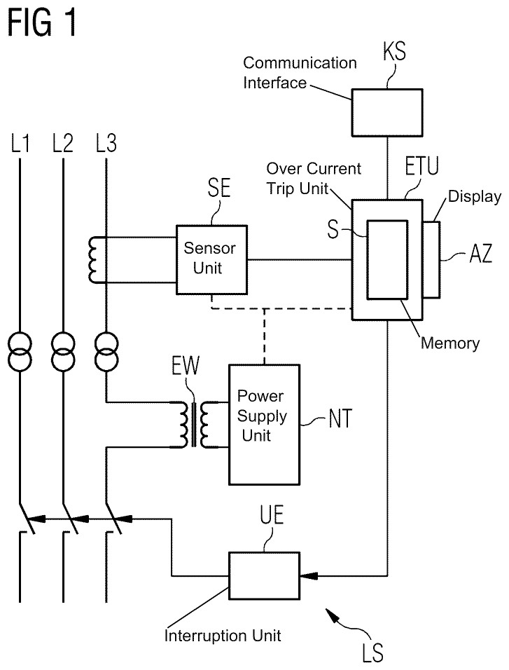

Referring now to the figures of the drawings in detail and first, particularly to FIG. 1 thereof, there is shown a portion of a circuit breaker LS, different units of the switch being shown schematically. The circuit breaker LS is intended to interrupt electrical conductors L1, L2, L3 of an electrical circuit, for example a three-phase AC circuit, wherein a first conductor L1 forms a first phase, a second conductor L2 forms a second phase and a third conductor L3 forms the third phase of the three-phase AC circuit. There may also be provision for a neutral conductor and a protective conductor.

In the example according to FIG. 1, the third conductor L3 is connected to an energy converter EW in such a way that at least a portion of the current, i.e. a partial conductor current, or the entire current of the third conductor flows through the primary side of an energy converter EW. The energy converter EW is usually a transformer with a core. There may also be provision for an energy converter EW in each phase, or in each conductor, of the electrical circuit. The secondary side of the energy converter EW is connected to a power supply unit NT that supplies energy, for example in the form of a supply voltage, for an electronic overcurrent trip unit ETU (Electronic Trip Unit). This overcurrent trip unit ETU is formed with a memory S. There is provision for a sensor unit SE, which, to determine the level of the electric current, is formed with at least one sensor element, preferably a Rogowski coil. In a common design variant, the level of the electric current of each phase conductor, or conductor, of the electrical circuit is determined.

The sensor unit SE is connected to the overcurrent trip unit ETU and transfers the level of the electric current of at least one or more conductors of the electrical circuit to the overcurrent trip unit ETU.

The transferred current values are compared in the electronic overcurrent trip unit ETU with current limit values and/or current/time period limit values, which form reasons for tripping. If the limit values are exceeded, interruption of the electrical circuit is prompted. This can be done, for example, by virtue of there being provision for an interruption unit UE, which is firstly connected to the electronic overcurrent trip unit ETU and secondly has contacts for interrupting the conductors L1, L2, L3, or further conductors, of the electrical circuit. The interruption unit UE in this case receives an interruption signal for opening the contacts.

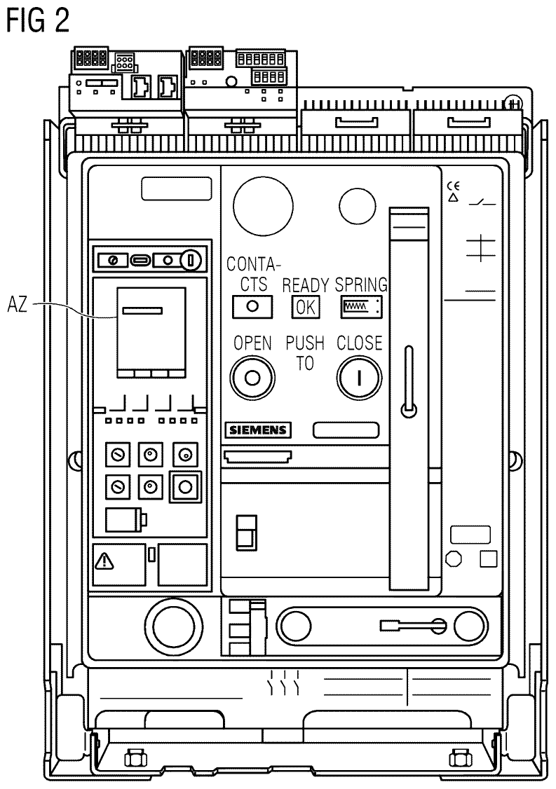

The electronic overcurrent trip unit ETU is provided with a display AZ on which values of system-relevant variables can be displayed, e.g. current, voltage, energy, power, phase angle, etc. Some of these variables are measured, and some are calculated from measured values. Also depicted is a communication interface KS (e.g. ZigBee, WiFi or BLE radio interface or cable interface, e.g. for LAN cables) via which the acquired system-relevant values can be transmitted e.g. to a monitoring point for display or analysis. Configurations are also conceivable in which there is no provision for a display on the electronic overcurrent trip unit ETU, but rather only provision for a display by an external unit to which information is transmitted. The calculation of system-relevant values from measured values can be performed both in the circuit breaker LS or by an external unit to which measured values have been transmitted. It is therefore also possible for the circuit breaker either to have no display AZ or to have no communication interface KS. In the first case, a display would then only be provided on the circuit breaker LS; in the second case, there would then only be provision for a display by an external unit that is fed with data from the circuit breaker. FIG. 2 shows the front view of a circuit breaker (ACB) having a display AZ.

The firmware for the display AZ is extended by special menu pages that allow a coded display of data as graphical code. This code encodes information stored in the memory S to produce internal logs. These are displayed on the display graphically, e.g. as a one-/multi-dimensional graphical code, e.g. barcode, QR code, data matrix code, or the like. In the event of a fault, the user can call up the special menu pages on the instructions of the customer service department, can photograph the displayed codes, e.g. using a cellphone, i.e. without special equipment, and can transfer them to the customer service department. After evaluating the codes, the customer service department can display the complete content of the log, analyze it and find a sound solution to the problem.

The electronic overcurrent trip unit ETU contains software for generating the code, e.g. a QR code generator that converts text to a QR code. Such software is prior art. (QR code generation is sometimes also offered on the Internet as a service, see https://www.qrcode-generator.de/solutions/text-qr-code/).

Such QR code generators can be used to display a simple text consisting of words, numbers and special characters in the form of a QR code. A QR code can typically store up to 7089 digits or 4296 characters, including punctuation and special characters. Thus, each code can encrypt not only individual words but also longer expressions, such as Internet addresses.

It is an important finding underlying the invention that the core information for an error-related log file entry, which is too extensive for conventional display on the switch, fits well into a graphical code, i.e. the graphical code is a suitable representation. This core information is e.g. the following content of a log entry:
date and time,
unique log ID (incrementing),
error/warning/event number, and
additional information, if necessary.

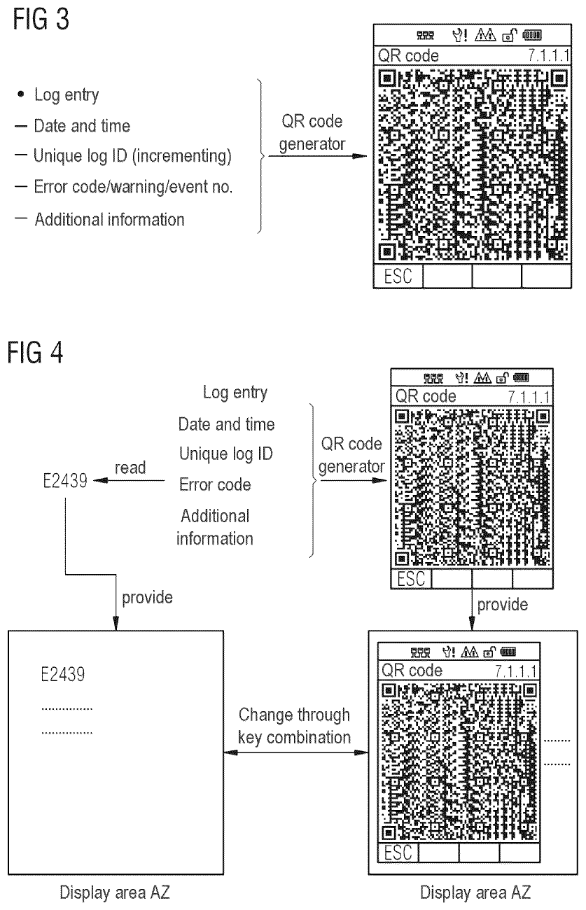

This information is used e.g. to generate a QR code, this being shown in FIG. 3.

The special menu pages can optionally be called up by repeatedly pressing keys at the same time, without being regularly available in the menu; and protected by a password that is valid only for this individual device and can be determined by the customer service department e.g. from the serial number and is issued only when a service request is made.

Another option is also display of the graphical code on an app (cellphone, tablet, or the like) that communicates with the ETU via a radio interface (e.g. Bluetooth) and evaluates the content of the logs.

FIG. 4 shows a method as an embodiment of the invention. Entries (including an error code) of a log entry are encoded in a QR code by means of the QR code generator. Moreover, the error code (“E2439”) is read and processed for output on a display area AZ. The display of this information on the AZ is shown schematically at the bottom left. As indicated by dots, the error code can additionally be used to output other information. Alternatively, the QR code is displayed on the display area (right). It is possible to change between these alternatives by means of a key combination.

The inventive solution permits the customer service department to access all data relevant to the error that are known to the ETU without overwhelming the user on the display with data that are meaningless to them. There are—apart from one-off implementation costs—no additional costs for the product, while maintainability is significantly increased. No additional special tool/diagnostic tool is required in order to read these data. The data are transferred with the highest reliability and transmission errors between the device and service personnel are avoided.

1. A switch, comprising:
an electronic overcurrent trip unit;
a memory associated with said electronic overcurrent trip unit for storing error-related log files;
a display; and
the switch being configured for conversion of information stored in the error-related log files into a graphical code and for outputting the graphic code on said display.

2. The switch according to claim 1, wherein the switch is configured for outputting of the graphical code on said display of the switch.

3. The switch according to claim 1, further comprising a communication interface and the switch is configured for transmission to a terminal having a terminal display for output of the graphical code on the terminal display.

4. The switch according to claim 1, wherein:
said display has a data processor; and
the switch is configured for conversion of the information stored in the error-related log files into the graphical code by said electronic overcurrent trip unit or said data processor of said display of the switch.

5. The switch according to claim 1, wherein:
the information contains an error code; and
the switch is intended for extraction of the error code by said electronic overcurrent trip unit and for output on said display of the switch.

6. The switch according to claim 5, wherein the switch is configured for alternative output of the error code and the graphical code on said display.

7. The switch according to claim 1, wherein the graphical code is able to be displayed on said display by means of a key combination.

8. The switch according to claim 1, wherein the output of the graphical code on said display is password protected.

9. The switch according to claim 1, wherein the information includes a date and time of an error, an identification number of a corresponding log file entry and an error code.

10. A method for outputting error-related information, which comprises the steps of:
providing a switch having an electronic overcurrent trip unit, a memory (S) associated with the electronic overcurrent trip unit for storing error-related log files, and a display;
converting information stored in the error-related log files into graphical code; and
outputting the graphical code on the display.

11. The method according to claim 10, which further comprises:
extracting error code from an error-related log file entry;
extracting further information from the error-related log file entry;
converting the error code and the further information to the graphical code;
providing the error code for output on the display; and
providing the graphical code for output on the display, it being possible to change between output of the error code and the graphical code on the display.
